(19) United States
(12) Patent Application Publication
(10) Pub. No.: US 2008/0072177 A1
(43) Pub. Date: Mar. 20, 2008

(54) Cascade menu lock

(75) Inventors: Lucinio Santos, Durham, NC (US); Richard D. Watts, Shrewsbury, MA (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation

(21) Appl. No.: 11/373,904

(22) Filed: Mar. 10, 2006

(51) Int. Cl. G06F 3/048

(52) U.S. Cl. 715/821

(57) ABSTRACT

The present invention is directed to a cascade menu lock for locking a normally closed cascade menu in the open state. Various levels of a cascade menu can be locked in the open state using a lock shortcut key or other user input. Unconstrained cursor movement is then possible without the locked menu collapsing. When locked, the locked menu level, and every related antecedent menu remain open until the lock is released by the user. Traditional cursor navigation rules may be broken without causing the collapse of the locked menu, such as diagonal and nonlinear cursory trajectories, and exiting the real estate of an open menu. Multiple menus may be locked open for simultaneously viewing the contents of each menu, and then unlocked using the lock shortcut. Hot spots may also be defined on one or more menu items, which are related to other related menu items, and enable the user to “jump” the cursor's position from the current menu item to another menu item without actuating the pointing device. When the cursor's screen position is detected over a snap position on a menu item, its screen position is automatically relocated to a second snap position in a descendant (or antecedent) menu item. Alternatively, the cursor jump may proceed only after receiving a user acknowledgement of the impending cursor jump.

### BACKGROUND OF THE INVENTION

1. Field of the Invention

The present invention relates to cascade drop-down menus. More particularly, the present invention relates to a system, method and software program product for locking cascade drop-down menus for enabling unconstrained cursor movement.

2. Description of Related Art

Cascade menus (sometimes referred to as cascading drop-down menus or cascading pull-down menus) are persuasive in operating system and application software. They are used in both menu bar pull-down and context menus. The menu structure is often a collection of hierarchically organized menu windows containing menu items that are related to a selected menu item in a higher level menu window. The menu structure allows the user to rapidly navigate through different hierarchical levels of the menu structure. Rarely do cascade menus contain over two cascading levels of information.

Cascade menus are intended for grouping and accessing nested menu items. Menu windows in a cascade displays are transitory by nature and adhere to a normally closed state. Initiating an active window state (i.e., opening a cascade menu window, as well as maintaining an open window state), usually requires the user make an affirmative action on the menu. Without receiving an action by the user, lower level cascade menu windows will return to their normally closed state up to the lowest active menu level. If the user navigates the cursor off the real estate of the menu, it closes completely.

Operationally, a secondary menu window is activated by positioning the cursor over a related item on a primary menu. The secondary menu window is populated with menu items related to the selected item in the primary menu. The sub-menu remains open and in the active state as long as the cursor remains positioned over the root item on the primary menu, unless it is repositioned onto any item in the sub-menu without leaving the area of the root menu item. When the cursor is moved off of the root item in the primary menu, the secondary menu returns to the normally closed state.

Due to the transitory nature of the cascade menus, they are not particularly useful for exploring menu items in depth or performing file maintenance. Nor are cascade menus particularly easy to use for the young, infirm or individuals with an unsteady hand. Accessing cascade menus using a pointing device requires a steady, straight horizontal movement to the end of the parent menu item (cascade menu opening hot spot). Even a slight departure from that linear movement results in the closing of the cascade menu. As a result accessing cascade menus require linear and perpendicular pointer (mouse) movements that are neither efficient (e.g., not the shortest paths), nor forgiving.

Other types of hierarchically organized menus have been devised with normally opened menu levels and items. These types of menus are usually tree-structured and enable users to drill much deeper into the file data without the apprehension of the menu structure collapsing.

### BRIEF SUMMARY OF THE INVENTION

The present invention is directed to a cascade menu lock for locking a normally closed cascade menu in the open state. While perusing various levels of a cascade menu, the user can lock open any currently opened menu with a lock shortcut key or other input. The lowest menu level, and each related antecedent menu, are locked open until released by the user. The user can then navigate the screen cursory unconstrained. In contrast with the prior art cascade menus that operate in a normally closed state, the present menu, with lock on, operates in a normally open state. Thus, traditional cursor navigation constrains may be broken without causing the collapse of the locked menu, such as diagonal cursory trajectories and exiting the real estate of an open menu. Multiple menus may be locked open for simultaneously viewing the contents of each menu, and then unlocked using the shortcut.

Hot spots may also be defined on one or more menu items which are related to other menu items for jumping to a related menu item. When a screen cursor is positioned over a snap position, its screen position is relocated to a second snap position in a cascade (or parent) menu item. The cursor jump may proceed automatically whenever the cursor position is detected over a snap position, or might instead be invoked manually using a shortcut key or the like.

### BRIEF DESCRIPTION OF THE SEVERAL VIEWS OF THE DRAWINGS

FIG. 1A is a screenshot of a typical cascade menu as is well known in the prior art and FIG. 1B is an uncluttered view of the screen cursor movements necessary for navigating a prior art cascade menu;

FIG. 2 is a flowchart depicting a method for operating cascading menus in response to screen cursor position as is known in the prior art;

FIG. 3A is a screenshot of a cascade menu employing a menu lock, for enabling a diagonal cursor trajectory in accordance with an exemplary embodiment of the present invention and FIG. 3B is an uncluttered view of the diagonal cursor trajectory;

FIG. 4 is a screenshot of a cascade menu with a jump cursor trajectory in accordance with an exemplary embodiment of the present invention;

FIG. 5 is a screenshot of a cascade menu simultaneously employing a cascade menu lock on multiple menus for comparing the contents of each locked menu in accordance with an exemplary embodiment of the present invention;

FIG. 6 is a screenshot of a cascade menu simultaneously employing a cursor constraint to the top level menu in accordance with an exemplary embodiment of the present invention; and

FIG. 7 is a flowchart depicting a process for implementing one or more of the features discussed above in accordance with an exemplary embodiment of the present invention.

Other features of the present invention will be apparent from the accompanying drawings and from the following detailed description.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times the code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The cascading drop down menu type of graphical user interface (GUI) is well known in the prior art and generally consists of a menu structure of hierarchically organized menu windows. Each cascade (or lower level) menu contains a list of menu items that relate to a selected menu item in an antecedent (or higher level) menu window. Cascade menus are opened by the user interacting with the related menu item listed in the antecedent menu window. Cascade menus usually drop-sideways rather than dropping directly down, but more important than the direction they drop to, is they are derived from a primary, parent menu. Thus we could simply refer to them as cascade menus.

The cascading menu structure allows the user to rapidly navigate through different hierarchical levels of the menu structure, but require strict adherence to certain navigation rules (or constraints) particular to cascade menus. For instance, if the user navigates the screen cursor off of the real estate area of a menu, or a related antecedent menu item for the menu, that menu window will collapse into the antecedent menu window (if an antecedent exists). Additionally, if the cursor moves off of all open menu windows, the cascade menu will completely close. While cascade menus provide users with a mechanism for quickly viewing hierarchical levels of a predefined menu items, these types of menu structures are not particularly useful for exploring menu items in depth or performing file maintenance. Furthermore, cascade menus are not particularly easy to manipulate for the young, infirm or those suffering from an unsteady hand, and are relatively difficult to manipulate with a touch pad or other low resolution pointing device.

In generally, the operation of cascade menu windows is determined by a set navigation rules for the menu, these rules are often predicted on the screen location of the screen cursor. Cascading menu windows may be considered normally closed and will open, or remain open, only by receiving specific interactions in conformance with the navigation rules. To keep a particular menu from returning to the normally closed state and collapsing, the user is obliged to maintain the position of the screen cursor over the particular menu, or a related menu item of not more that one degree of consanguinity to the particular menu. The operation of a typical prior art cascade menu may be better understood with visual reference to such a menu.

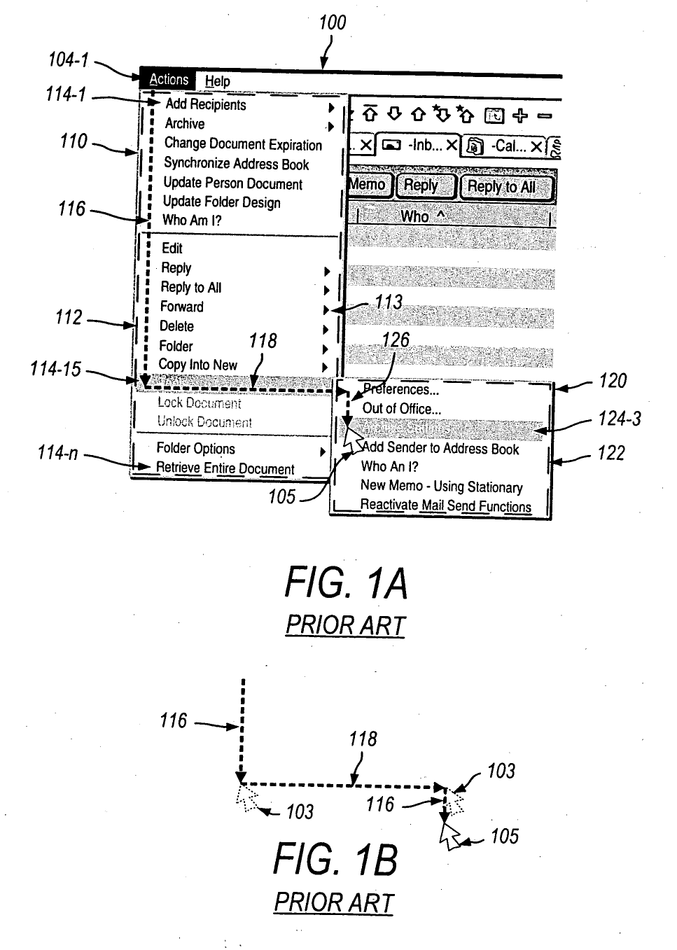

FIG. 1A is a screenshot of a typical cascade menu as is well known in the prior art. FIG. 1B is an uncluttered view of the screen cursor movements necessary for navigating a prior art cascade menu. In describing the present invention, a parent or higher level menu or menu item will be referred to alternatively as a parent, antecedent or high level screen object. Conversely, a child or lower level menu or menu item will be referred to alternatively as being a child, descendant or low level screen object. A cascade (descendant) menu is initially opened by selecting a top level menu item, such as the “Actions” menu item 104-1 in task bar 100. In accordance with the example depicted in the screenshot, the top level of menu items is always on top and visible unless closed by the user, i.e., normally open. Alternatively, the top level may exist under normally closed constraints and may not be visible unless the top level menu is activated by the user. Often, the selecting action requires no more than the user positioning the screen cursor over a parent (antecedent) menu item. In response, high level menu 110 cascades open, or drops down from task bar 100, revealing menu items 114-1 through 114-n, which are each descendants of the Actions menu item 104-1. The list of menu items 114-1 through 114-n are displayed entirely in the area of high level menu 110 or real estate 112.

High level menu 110 will remain open only so long as the screen position of cursor 105 remains located over the area of the current menu (i.e., real estate 112 of menu 110), or over a related antecedent menu item (i.e., the “Actions” menu item 104-1), or over any descendent menu or descendant menu item to any of the current menu items (i.e., any descendant of menu items 114-1 through 114-n, as depicted in the figure, cursor 105 is located over real estate 122 of a descendant menu 120, more particularly over a descendant of menu item 114-15). Most graphical user interface elements, such as menu items, will echo a visual confirmation of the position of screen cursor 105 to the user, such as by emphasizing textual menu items or emphasizing the adjacent area of the menu item, for instance by highlighting, bolding or shading the respective areas. In the figure, cursor 105 is shown over lower menu item 124-3. If screen cursor 105 moves off of menu item 124-3, the item deemphasized, and a new menu item emphasized based on the new position of screen cursor 105. Generally, the direct line of antecedent menu items will also be emphasized as depicted with the shading of higher level menu item 114-15.

Certain menu items in menu 110 may also display an icon, such as arrow 113, which provides the user with a visual indicator that a descendant or lower level cascade menu exists for that menu item. Typically, root menu items are not executable, except for viewing their descendants, so a user must navigate to the lowest menu level for executable menu items. The user simply navigates to a menu item with an arrow to reveal the descendants. For many menus, a descendant menu will open automatically in response to the cursor's position being detected over a parent menu item (simultaneously with the emphasis of that item). From the parent menu, the user can navigate to any descendant menu items, but must adhere to strict navigation rules in traversing the current menu to the newly opened descendant menu. As mentioned directly above, one such rule requires the cursor's position to remain over the antecedent menu item for its next descendant menu to remain open. With regard to the cascade menu depicted in FIG. 1, the position of screen cursor 105 should not deviate off of menu item 114-15 prior to reaching lower level menu 120, or lower level menu 120 will collapse and menu items 124-1 through 124-m will not be accessible.

Some prior art cascade menu implement navigation rules that avoid the premature closing of an open drop down menu due to a fleeting change of screen curser 105 off of the emphasized menu item. This is typically accomplished by requiring the position of screen cursor 105 to remain over a new menu item for a predetermined time period to the in order to invoke a visual confirmation of the position of screen cursor 105, i.e., emphasizing the menu item, closing and opening descendants, etc.

The peculiar navigation rules for cascade drop down menus often necessitate the user manipulating the position of screen cursor 105 in a series of strict vertical and horizontal screen movements with corresponding vertical and horizontal pointing device motions. For instance, as the user traverses high level menu 110, screen cursor 105 moves in a generally vertical direction a target menu item is reached, depicted in FIGS. 1A and 1B as vertical curser trace 116. The user may execute that menu item by “clicking” a button on the pointing device, or may instead desire to select an item on a descendant menu to the target menu item by navigating to that descendant menu. As shown, screen cursor 105 traverses current menu 110 and across the target menu item 114-15 without departing the active area adjacent to menu item 114-15. To avoid the premature closure of lower menu 120, and assuring lower menu 120 will be available for receiving screen cursor 105, the trajectory of screen cursor 105 proceeds along generally horizontal direction, shown as horizontal cursor trace 118, until reaching real estate 122 of lower menu 120. The user then traverses lower level menu 120 in the same manner as upper level menu 100, in a generally vertical direction, vertical curser trace 126, until reaching a target menu item on menu 102, e.g., menu item 124-3.

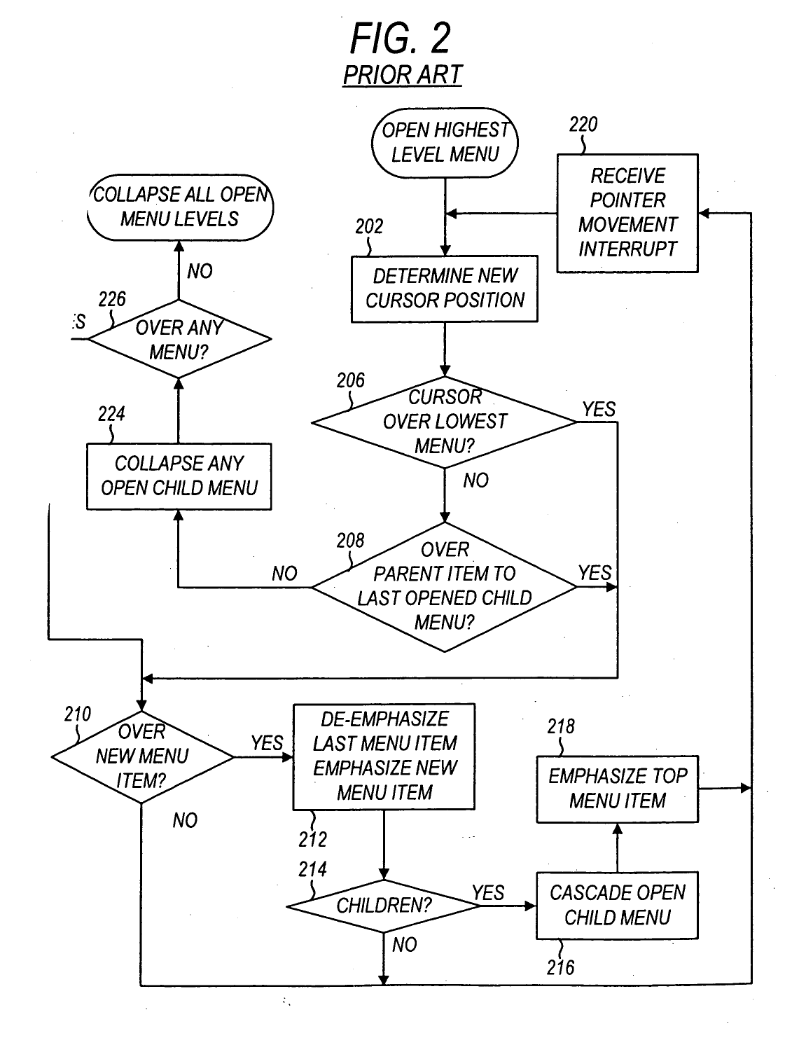

In operation, the cascade menu process continually checks the screen position of the cursor with respect to open menus and menu items. If the process cannot validate an open state for a menu based on screen position, that menu is immediately closed. The operation of prior art cascading menus in response to screen cursor position is depicted in the flowchart in FIG. 2. The process begins by opening a high level menu window, such as by selecting a menu item on the task bar of an application or operating system. In the initial iteration, the process determines a new screen position for the cursor without receiving a pointer interrupt from the pointing device, but after the initial position of the cursor has been determined, the movement interrupts from the pointing device are used for calculating updated screen positions (step 202). Next, the process checks whether or not the cursor is positioned over the lowest level menu (step 206). If it is, the process then determines whether or not the menu item is a new item, or remains on the current menu item (step 210). If the screen cursor has not moved off of the last menu item, the process returns to a ready state for receiving new pointer position interrupts.

Returning to step 206, if the cursor's screen position is determined not to be over the lowest level menu, the process checks whether or not the cursor is over a parent item to the last opened child menu, i.e., the lowest level menu (step 208). Usually, the navigation rule dictate that the lowest level cascade menu window will remain open in only two cases; if the cursor is over the real estate of the lowest level menu window (the current menu window) or if it is over a related antecedent menu item in the parent menu (i.e., the next highest menu). For instance, when initially opened, the cursor will be positioned over a menu item of the task bar (the task bar itself may be considered a parent menu), but not yet on the newly opened drop down menu, which forces the descendant menu for the selected task bar item to remain open. The process will detect that the cursor position has not moved off of the current menu item (step 210), and returns to the ready state for receiving new pointer position interrupts. If, at step 208, the position of the cursor is not over an antecedent menu item for the last opened descendant menu, that descendant menu is collapsed (step 224), and the process checks if the cursor is over any menu window (step 226). If the cursor is not over any open menu, the menu returns to its normally closed state, all opened menus are collapsed, and the process end.

Alternatively, if the cursor position is determined to be over some open menu, but not over the lowest menu level or its antecedent menu item, the cursor must have moved off of the previous menu item and onto a new menu item (step 210). Then the previously emphasized menu item is deemphasized and the new menu item is emphasized (step 212). The new menu item is then checked for descendant menu items which will appear listed in a new drop down menu. If the current menu item is executable, i.e., it has no descendants, the process returns to a ready state for receiving new pointer position interrupts. Alternatively, if the current menu item has descendants, a lower level menu containing the descendant menu items is opened (step 216) and the top menu item in the list is emphasized (step 218). The process returns to a ready state for receiving new pointer position interrupts.

After the initial iteration, where the highest menu level is opened, the process is dormant until a pointer interrupt is received from the pointing device (step 220), at which time the process determines the new screen position for the cursor (step 202). Here again, the navigation rules constrain the outcome to one of three possibilities based on the cursor position. If the new cursor position is determined to be over the lowest open cascade menu, either on the current menu item or a new menu item in the cascade menu (step 206), then both the antecedent menu item and descendant menu item will be emphasized (steps 210-218). Alternatively, if the new cursor position is determined to be over an antecedent (parent) menu item (steps 208-226), either on the current antecedent menu item (step 208) or a new menu item in the parent menu (step 226), the antecedent menu item will be emphasized along with the top menu item in any cascade menu that may exist for the parent menu item (steps 210-218). Finally, if the new cursor position is determined to be off of the entire menu (steps 226), then the menu collapses, including cascade menus, and the process ends.

As should be appreciated from the discussion above, each instance in which the cursor position is determined to be off of the current menu item, the current menu item is deemphasized and the new menu item emphasized. However, even more importantly in the context of the prior art, whenever the menu item is deemphasized (i.e., the cursor is not over one of the items in the cascade menu or the parent menu for the cascade menu), the previously opened cascade menu collapses and a new cascade menu, the new cascade menu id populated with descendant items associated with the new parent menu item, opens. Thus, the user should use particular care in navigating to a descendant menu, or else it will collapse and the menu items unavailable for selecting. This makes it particularly difficult for the young, infirm or individuals with an unsteady hand to navigate from one menu level to another. These navigation rules also make it more difficult to operate cascade menus with a touch pad or other low resolution pointing device. Furthermore, the vertical-horizontal-vertical screen cursor navigation movements are counterintuitive. When a drop down menu opens, the user tends to move the screen cursor directly toward a target menu item in the newly opened menu, whether or not the target item occupies the top entry position in the newly opened menu. This often results in the lower menu closing, in all but the case where the target item occupies the top entry position. Thus, the navigation rules employed by prior art cascade menus are biased against moving in any screen direction other than vertical and horizontal. Obviously then, the user cannot always navigate the shortest trajectory (which is a screen diagonal) between the current menu item and a particular menu item in the newly opened menu

A cascade lock is disclosed in accordance with one exemplary embodiment of the present invention for locking cascading menus in the open position and thereby enabling unconstrained cursor trajectories, such as diagonally moving from a current menu item to a descendant menu item without collapsing the descendant menu. Locking can be instantiated using a shortcut key, such as “Control” or “Shift” keys with the cursor positioned over a particular menu item, or might instead be mouse enabled as a context menu option to a right button mouse click. Locking is removed using the same shortcut key. Alternatively, temporary locking may be accomplished by holding the shortcut key, and locking terminated by releasing the shortcut key.

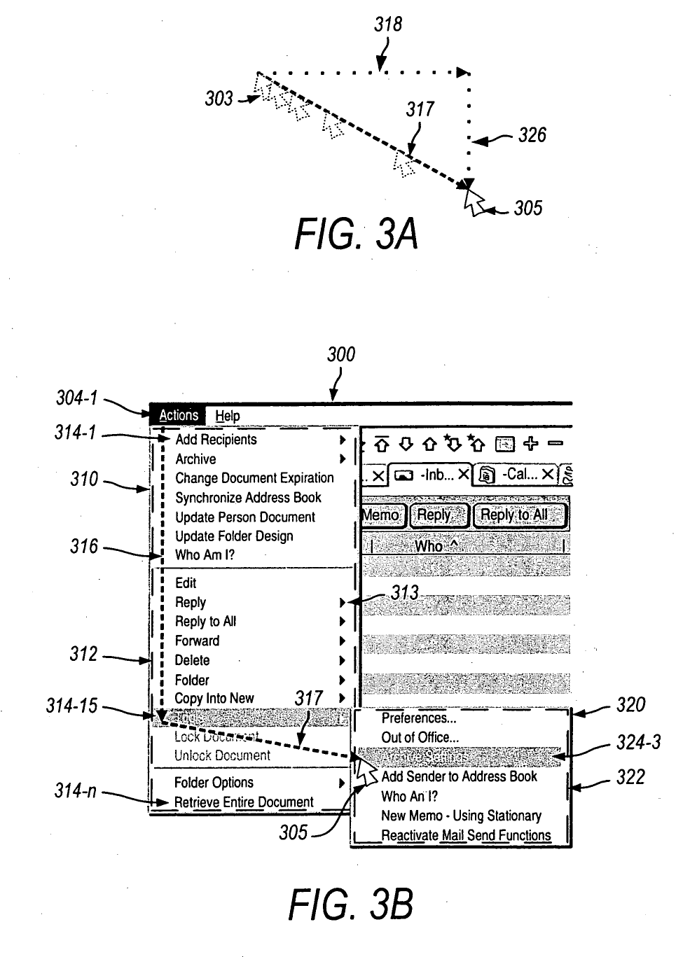

FIG. 3A is a screenshot of a cascade menu employing a menu lock, for enabling a diagonal cursor trajectory in accordance with an exemplary embodiment of the present invention and FIG. 3B is an uncluttered view of the diagonal cursor trajectory. The cascade menus depicted in FIG. 3A is similar to that discussed above with regard to FIG. 1A, like menu features are correspondingly labeled and therefore only the unconstrained cursor navigation features will be discussed.

Here, the user intends to explore the “Tools” menu item for a tool selection. According to the prior art, the user would navigate the cursor on vertical trajectory 312, to Tools menu item 314-15, on horizontal trajectory 318 traversing Tools menu item 314-15 and once on lower menu level 320, traversing vertical trajectory 326 to “Archive Setting” menu item 324-3. By contrast, using the cascade lock feature the user merely navigates to the top open menu level, e.g., parent menu level 310, until the desired descendant menu cascades open, i.e., menu level 320. Then, rather than moving the cursor in a horizontal trajectory to keep menu 320 open, the cascade lock function is actuated (this is designated on the figure as a circle in the cursor trajectory). Essentially, the cascade lock function switches the menu's navigation constraints from a normally closed menu (in which the process continually checks for a reason to keep the menu open), to a normally open menu (in which the present process continually checks for a reason to close the menu). The locking mechanism keeps the cascade menu open until an explicit gesture is made to close it, as opposed to being close automatically according to the cursor position boundaries that govern standard cascade menus. Whether or not the cursor is positioned directly over the cascaded menu, or its parent menu item, has no bearing on the visual state of the cascaded menu. Once locked, the user may make the most direct trajectory from the antecedent menu item to any menu item in a descendant menu level, such as diagonal trajectory 317. Experienced users will be able to traverse the fastest and most direct trajectories from one menu entry to the next, while less experienced users and the infirm will not suffer the hardship of descendant menus repeatedly closing before the screen cursor can be precisely positioned over the newly opened descendant menu.

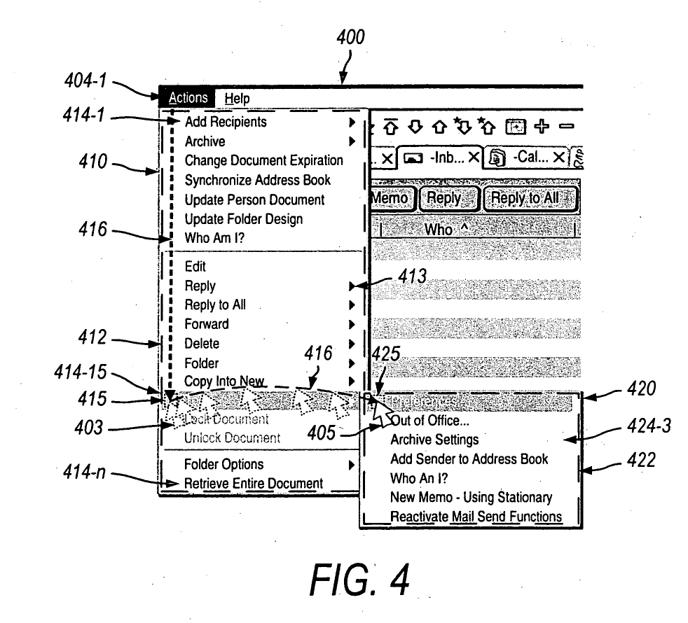

In accordance with another exemplary embodiment of the present invention, a snap feature for automatically jumping the screen location of the screen cursor from a first snap position on one menu item to a second snap position on a related menu item in a cascade menu. FIG. 4 is a screenshot of a cascade menu depicting a jump cursor trajectory in accordance with an exemplary embodiment of the present invention. A cursor jump may be executed from one menu item to a related menu item (usually a parent menu to a child menu, or vice versa) in one of two ways. First, the user merely positions screen cursor 405 over first snap position 415 on menu item 414-15. The process may query the user as to the intention, e.g., “Jump to ‘Preferences’?” Any response except an affirmation will not result in a jump. Alternatively, once the process recognizes the screen position of cursor 405 as being over first snap position 415, jump 416 automatically repositions cursor 405 to jump position 425 on the top entry, menu item 424-1. A time delay may also be employed to prevent premature jumping from the current menu item to an unintended destination. The second way to jump cursor 405 is by again using a shortcut key, such as “Control” or “Shift” keys, or as a context menu option to a right button mouse click. The second option affords the user with the ability to perform a jump from any position on a menu item (not only from a pre-designated the snap position) to a position on a related menu item. The snap feature also expedites reaching the target item by shortening the cursor trajectory between the current and target items. Although the jump is depicted in FIG. 4 as traversing from a higher level menu to a lower level menu, it may, instead, proceed in the opposite direction to a higher level menu from its descendant. Snap positions 415 and 425 may also be provided with a “gravity” attribute for less experienced users and the infirm, wherein cursor 405 is attracted to the snap location by a gravitational force which is inversely proportional to the cursor's screen position distance from the snap position. Gravity will also tend to expedite reaching a target item from a current cursor screen position by shortening the cursor trajectory therebetween.

In accordance with still another exemplary embodiment of the present invention, the lock feature may be simultaneously employed to lock two or more menus, on two or more menu levels. An inexperienced user may search menu items for a familiar entry in the hopes of jogging their memory. Since, in the prior art, individual menus are open sequentially, often the user will become confused or merely select the first familiar looking menu item, only to discover the selection was incorrect. Furthermore, even a seasoned user may benefit from the opportunity to compare one set of menu items with a second set (or multiple sets) of menu items. Since prior art cascade menus are sequentially opened, the comparison must be made on the fly and relying on memory (i.e., opening one menu, closing it, and opening a second menu). Having multiple cascade menus opened simultaneously facilitates the comparison of menu items without memorization. Furthermore, having multiple cascade menus opened simultaneously allows users to scan a larger set of menu items at once, thus facilitating the location of the desired item.

According to the present invention, the cascade locking can be instantiated using a shortcut key with the cursor positioned over a particular menu item, or by selecting a context menu option to a right button mouse click, as discussed above. Unlocking a menu is accomplished in the same manner, positioning the cursor over a locked menu, and using the shortcut key. Temporarily locking a menu is also possible, but may be limited to the last open menu only. Menus that are locked prior to opening the current menu should be non-temporarily locked to avoid conflicts between two temporarily opened menus.

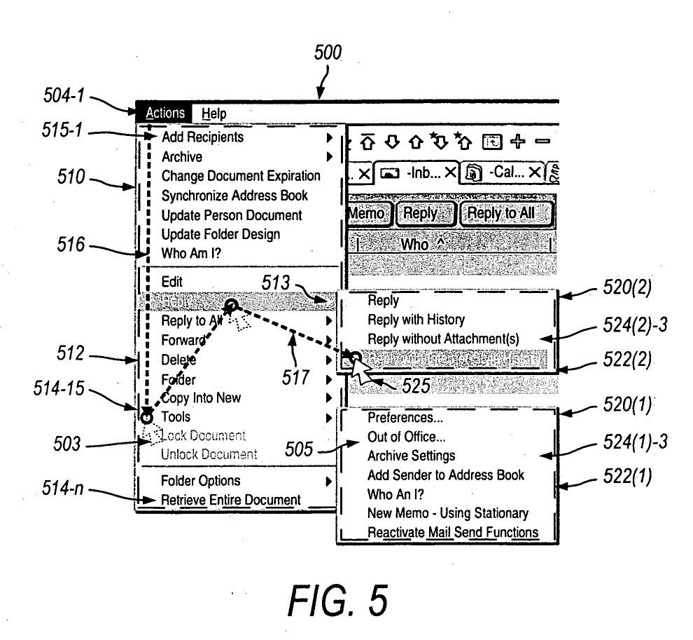

FIG. 5 is a screenshot of a cascade menu simultaneously employing a cascade menu lock on multiple menus for comparing the contents of each locked menu in accordance with an exemplary embodiment of the present invention. Here, the user may be unsure of which menu option is the best selection and utilize multiple menu locks for simultaneous viewing two or more open cascade menus. As depicted in the example, the user initially intends to explore the “Tools” menu item 514-15 for a tool selection. Using the cascade lock feature, the user merely navigates to the top open menu level, e.g., parent menu level 510, and over a first menu item, e.g., Tools item 514-15, thereby opening the desired cascade menu, i.e., Tools lower menu level 520(1). Without receiving further input from the user, Tools lower menu level 520(1) will remain open as the top window level. The user may then position the cursor over a second menu item for opening its corresponding second lower level menu, such as “Reply” menu item 514-9 for opening lower menu level 520(2). With both cascade menus locked in the open position, the user may leisurely compare the Reply menu items with those contained in Tools lower menu level 520(1). For convenience, the user may navigate between menu entries via diagonal trajectory 517 or using snap positions (not shown).

In accordance with still another exemplary embodiment of the present invention, the location of the screen cursor may be constrained to the real estate of a particular menu level, thereby enabling the user to peruse the current menu items without the concern of the menu closing or using the cascade lock feature. Each of the descendant menus can then be opened individually by navigation throughout the menu. According to the present invention, the cursor position is constrained using a shortcut key or the like as discussed above.

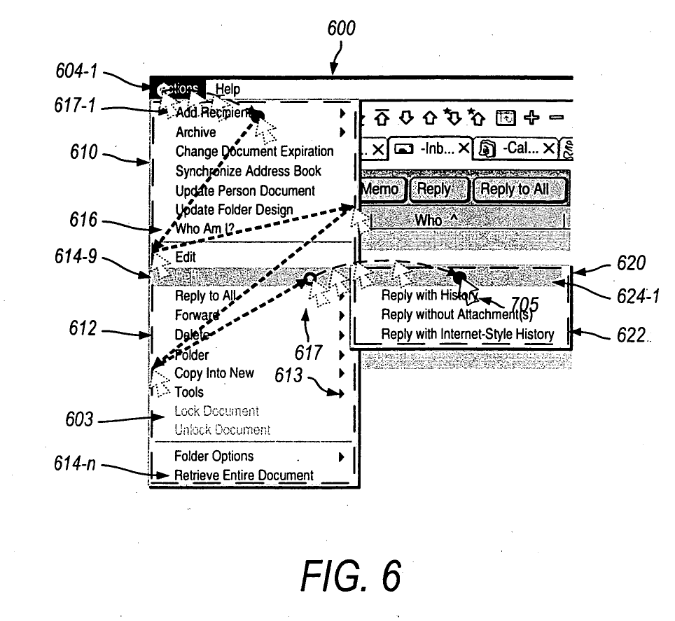

FIG. 6 is a screenshot of a cascade menu simultaneously employing a cursor constraint to the top level menu in accordance with an exemplary embodiment of the present invention. Here, the user initiates the cursor constrain feature simultaneously with opening a menu, for instance, by holding the shortcut key when simultaneously selecting task item “Actions” 604-1. Because the position of the cursor is constrained to the top layer, it is automatically reposition on the top menu item, item 617-1. In response the receiving user interactions from the pointing device, the cursor constrain process calculates a new screen position of the screen cursor, compares that position with the area of real estate 612, and if the cursor position is determined to be off real estate 612, it is repositioned to the last position calculated within real estate 612 (alternatively, the cursor is repositioned to the closest position within real estate 612). The user may navigate off real estate 612 by locking a lower level menu (in which case cursor 605 is constrained to real estate of 622, in addition to real estate of 612). Optionally, the area of the cursor constraint is extended to any opened descendant menu, or the cursor may be constraint to each open menu, independently. For more even control, the cursor constrain feature can be coupled with the cascade lock, whereby the cursor's screen position is constrained to a locked menu. Combining these features gives those users with an unsteady hand the control necessary to navigate a cascade menu.

As may be appreciated from the discussion above, the presently described invention may be implemented into the prior art cascade menu process in whole or part with only minimal modifications to the prior art navigation rules and process.

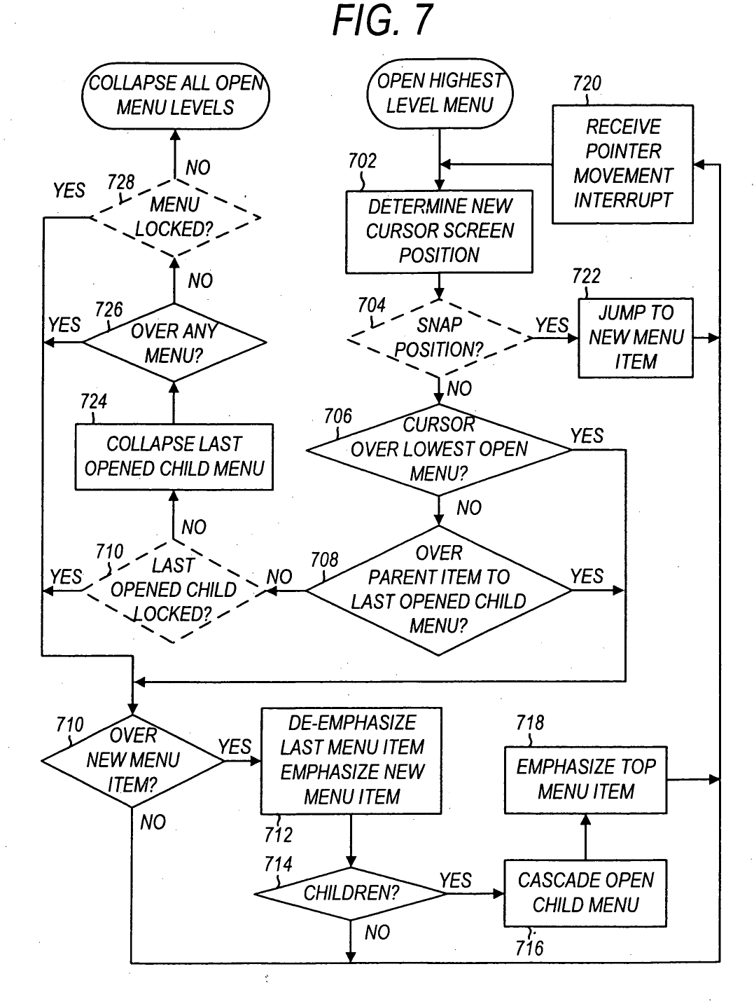

FIG. 7 is a flowchart depicting a process for implementing one or more of the features discussed above in accordance with an exemplary embodiment of the present invention. The process begins with by opening of a high level menu window, and then, in the initial iteration, the process determines a new screen position for the cursor without receiving a pointer interrupts from the pointing device (step 702). If cursor position constraints are activated, the new cursor position is checked to determine if the position is within the constrained real estate area. If the position is not within the constrained area, the last cursor position in the constrained area is substituted for the newly calculated screen position. If the screen location is determined to be within the constrained area (or position constraints are not active), the new cursor position is checked against the snap positions for the menu (step 704). If the cursor is currently located over a snap position, the location of the cursor is jumped to a second snap position location on the related menu item, typically with one degree of consanguinity of the current menu item (step 722). If the cursor is not over a snap position, the process checks whether or not the cursor is positioned over the lowest level menu (step 706) and if not, whether the cursor is over a parent item to the last opened child menu (step 708). If both tests fail, the state of the last opened menu is checked, that is, whether the last opened menu is currently locked open (step 709). If it is locked, the last opened menu and all related higher level menus remain in the open state and the process proceeds to step 710 to determine whether or not the cursor is over a new menu item. If, however, it is determined (at step 709) that the last open child menu is not locked, that open menu collapses (step 724), and the process determines whether the cursor is positioned over any open menu window (step 726). If it is, the process proceeds to step 710 for determining whether or not the cursor is positioned over a new menu item. If, at step 726, it is determined that the cursor is not over any open menu, the state of all previously opened menu(s) are checked for being currently locked open (step 728). If none are locked, the previously opened menu(s) return to their normally closed state. However, if any one of the previously opened menus is locked, that menu remains open as well as each of its antecedent menus and the process again proceeds to step. It should be appreciated that the lock menu tests are performed only if all other conditions fail that are necessary to keep a particular menu window open. Thus, the process progresses similarly with the prior art unless a navigation rule is violated that may result in a menu being closed, such as executing a diagonal cursor trajectory or exiting the real estate of an open menu window.

The remainder of the process proceeds as discussed with regard to the prior art process depicted in FIG. 2. At step 706, if at step 708 the screen position of the cursor is determined to be over a new menu item, the process again proceeds to step 710 for determining whether the new position correlates to a new or the current menu item. If the cursor position is determined to be over a new menu item, whether or not the current or a previously opened menu is locked, the old menu item is deemphasized and the new menu item is emphasized (step 712), and a check for children menu is made. If the new menu item has no children, the process returns to a ready state for receiving new pointer position interrupts. Conversely, the new menu item does have related child menu items, the lower level menu containing the children items is opened (step 716) and the top entry in the list is emphasized (step 718). The process returns to a ready state for receiving new pointer position interrupts.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A method for navigating a screen cursor with a cascading menu, comprising:
determining a screen location for a screen cursor;
comparing the screen location for the screen cursor with an active area for a menu item in a cascading menu window;
determining a menu lock state for one cascading menu window; and
maintaining the one cascading menu window in the open state based on the menu lock state of the one cascading menu window.

2. The method for navigating a screen cursor recited in claim 1, further comprising:
resolving to collapse the one cascading menu window based on the comparison of the screen location for the screen cursor and the active area for the menu item in the cascading menu window; and
maintaining the one cascading menu window in the open state based on the menu lock state of the one cascading menu window to the contrary of the resolution to collapse one cascading menu window based on the comparison of the screen location.

3. The method for navigating a screen cursor recited in claim 1, wherein the one cascading menu window is a cascaded descendant menu window of the cascading menu window.

4. The method for navigating a screen cursor recited in claim 1, further comprising:
receiving a plurality of user inputs defining a diagonal screen cursor trajectory between the menu item in the cascading menu window and a second menu item in the one cascading menu window;
determining a screen location for each of the plurality of user inputs;
comparing each of screen locations corresponding to each of the plurality of user inputs for the screen cursor to the active area for the menu item in the cascading menu window;
resolving to collapse the one cascading menu window based on the comparison of each screen location for the screen cursor and the active area for the menu item in the cascading menu window;
determining the menu lock state for the one cascading menu window; and
maintaining the one cascading menu window in the open state during the diagonal screen cursor trajectory between the menu item in the cascading menu window and the second menu item in the one cascading menu window based on the menu lock state of the one cascading menu window.

5. The method for navigating a screen cursor recited in claim 1, further comprising:
receiving a plurality of user inputs defining a nonlinear screen cursor trajectory between the menu item in the cascading menu window and a second menu item in the one cascading menu window;
determining a screen location for each of the plurality of user inputs;
comparing each of screen locations corresponding to each of the plurality of user inputs for the screen cursor to the active area for the menu item in the cascading menu window;
resolving to collapse the one cascading menu window based on the comparison of each screen location for the screen cursor and the active area for the menu item in the cascading menu window;
determining the menu lock state for the one cascading menu window; and
maintaining the one cascading menu window in the open state during the nonlinear screen cursor trajectory between the menu item in the cascading menu window and the second menu item in the one cascading menu window based on the menu lock state of the one cascading menu window.

6. The method for navigating a screen cursor recited in claim 1, wherein the one cascading menu window is the cascading menu window.

7. The method for navigating a screen cursor recited in claim 1, further comprising:
receiving a user input; and
toggling the menu lock state for the one cascading menu window based in the user input.

8. The method for navigating a screen cursor recited in claim 7, wherein the user input is generated by key stroke to a pre-designated key on a keyboard.

9. The method for navigating a screen cursor recited in claim 7, wherein the user input is generated by a user interaction with a pointing device.

10. The method for navigating a screen cursor recited in claim 1, further comprising:
determining a second screen location for the screen cursor;
comparing the second screen location for the screen cursor to an active area for a second menu item in a cascading menu window;
resolving to collapse a second cascading menu window based on the comparison of the screen location for the screen cursor and the active area for the second menu item in the cascading menu window;
determining the menu lock state for the second cascading menu; and
maintaining the second cascading menu in the open state based on the menu lock state of the one cascading menu.

11. The method for navigating a screen cursor recited in claim 1, further comprising:
comparing the screen location for the to a snap position on the menu item in the cascading menu window; and
jumping the screen cursor from the screen location to a second screen location on a second menu item based on the comparison of the screen location for the screen cursor to the snap position on the menu item in the cascading menu window.

12. The method for navigating a screen cursor recited in claim 1, further comprising:
relocating the screen cursor to a position on the cascading menu window based on the comparison of the screen location for the screen cursor and the active area for the menu item in the cascading menu window.

13. A computer program product comprising a computer usable medium having computer usable program code for navigating a screen cursor with a cascading menu, said computer program product comprising:
computer usable program code to determine a screen location for a screen cursor;
computer usable program code to compare the screen location for the screen cursor with an active area for a menu item in a cascading menu window;
computer usable program code to determine a menu lock state for one cascading menu window; and
computer usable program code to maintain the one cascading menu window in the open state based on the menu lock state of the one cascading menu window.

14. The computer program product in claim 13, further comprising:
computer usable program code to resolve to collapse the one cascading menu window based on the comparison of the screen location for the screen cursor and the active area for the menu item in the cascading menu window; and
computer usable program code to maintain the one cascading menu window in the open state based on the menu lock state of the one cascading menu window to the contrary of the resolution to collapse one cascading menu window based on the comparison of the screen location.

15. The computer program product in claim 13, wherein the one cascading menu window is a cascaded descendant menu window of the cascading menu window.

16. The computer program product in claim 13, further comprising:
computer usable program code to receive a plurality of user inputs defining a non-horizontal and non-vertical screen cursor trajectory between the menu item in the cascading menu window and a second menu item in the one cascading menu window;
computer usable program code to determine a screen location for each of the plurality of user inputs;
computer usable program code to compare each of screen locations corresponding to each of the plurality of user inputs for the screen cursor to the active area for the menu item in the cascading menu window;
computer usable program code to resolve to collapse the one cascading menu window based on the comparison of each screen location for the screen cursor and the active area for the menu item in the cascading menu window;
computer usable program code to determine the menu lock state for the one cascading menu window; and
computer usable program code to maintain the one cascading menu window in the open state during the diagonal screen cursor trajectory between the menu item in the cascading menu window and the second menu item in the one cascading menu window based on the menu lock state of the one cascading menu window.

17. The computer program product in claim 13, further comprising:
computer usable program code to receive a user input; and
computer usable program code to toggle the menu lock state for the one cascading menu window based in the user input.

18. The computer program product in claim 17, wherein the user input is generated by key stroke to a pre-designated key on a keyboard.

19. A system for navigating a screen cursor with a cascading menu comprising:
a display device;
a memory for storing a set of navigation rules and screen positions for a plurality of screen items on the display device;
a pointing device; and
a data processor to receive movement interrupts from the pointing device, determine a screen location for a screen cursor on the display device, compare the screen location for the screen cursor with an active area for a menu item in a cascading menu window of the display device based on the set of navigation rules, determine a menu lock state for one cascading menu window and maintain the one cascading menu window in the open state in the display device based on the menu lock state of the one cascading menu window.

20. The system in claim 19, wherein the data processor resolves to collapse the one cascading menu window in the display device based on the comparison of the screen location for the screen cursor and the active area for the menu item in the cascading menu window and the set of navigation rules, and maintains the one cascading menu window in the open state in the display device based on the menu lock state of the one cascading menu window to the contrary of the resolution to collapse one cascading menu window based on the comparison of the screen location.
